(19) United States
(12) Patent Application Publication
(10) Pub. No.: US 2011/0158727 A1
(43) Pub. Date: Jun. 30, 2011

(54) PRINTING APPARATUS AND CONTROL METHOD FOR PRINTING APPARATUS

(75) Inventor: Junichi Yamakawa, Hiratsuka-shi (JP)

(73) Assignee: CANON KABUSHIKI KAISHA, Tokyo (JP)

(21) Appl. No.: 12/975,311

(22) Filed: Dec. 21, 2010

(30) Foreign Application Priority Data
Dec. 26, 2009 (JP) 2009-296525

(51) Int. Cl. G03G 15/00

(52) U.S. Cl. 399/407

(57) ABSTRACT

A control method for controlling a printing apparatus includes printing an image on a sheet by a printing unit, changing a sheet discharge position of the sheet printed by the printing unit, controlling the printing unit to execute a printing operation to continuously print an image of each page contained in image data of a plurality of pages on sheets in turn by a specified number of copies, changing the sheet discharge position after the printing operation is executed, and controlling the printing unit to execute the printing operation after the sheet discharge position is changed and then to discharge the sheets printed by the printing operation to the changed sheet discharge position.

### BACKGROUND OF THE INVENTION

1. Field of the Invention

The present invention relates to a printing apparatus and a control method for the printing apparatus.

2. Description of the Related Art

Recently, on printing from a host computer (information processing apparatus), a printing apparatus becomes widespread which not only executes printing of a document but also is mounted with a finisher, such as a stapler and a sorter. The printing apparatus has enough memory to store every page of a document and allows collate printing.

The collate printing refers to a method of repeatedly printing, for example, ten pages in the order of the first page to the tenth page after ten pages are printed in the order of the first page to the tenth page when two copies of a printed product having ten pages are printed. More specifically, the collate printing refers to a printing method of repeatedly executing an operation to print one copy of a printed product having some number of pages in the order of page for a specified number of copies. Since the collate printing becomes possible, a finisher having a multi-bin sorter is changed to a finisher having two or three output bins.

In printing using the finisher, a printing apparatus system is also discussed which has the function of not only applying finish processing in units of a print document but also shifting the printed product of a plurality of numbers of copies in units of a number of copies specified in collate printing (e.g., refer to Japanese Patent Application Laid-Open No. 2007-99479).

Further, a printing apparatus is discussed in which also with respect to the types of finish, not only sorting is executed but also stapling, saddle stitch binding, punching, and the like are executed by a specified number of copies (e.g., refer to Japanese Patent Application Laid-Open No. 2007-265388).

Furthermore, as a different printing method from the collate printing, there is a method of group printing. The group printing refers to a printing method in which when two copies of a printed product having ten pages are printed, an operation to print the first page twice, then, print the second page twice, and print the third page twice is repeated up to the tenth page. More specifically, the group printing refers to a method of printing a printed product having some number of pages for a specified number of copies for each page to repeatedly print it for the number of pages.

However, in the group printing, the conventional technique is unable to execute outputting in units of a specified number of copies, shift outputting, and breaking by a partition sheet.

In order to obtain an output product in units of a specified number of copies by the group printing, there is also a method to divide printing into a plurality of print jobs to input the divided plurality of print jobs, thereby executing printing. In this case, another job is permitted to cut in between print jobs to be divided and input. For example, when the divided and input plurality of print jobs forms a line in a print queue, it is considered that the order of priority of another job is raised by a user operation and this another job is inserted into the plurality of print jobs. In this case, the result of printing of another job is mixed in the result of printing of the divided and input plurality of print jobs.

### SUMMARY OF THE INVENTION

According to an aspect of the present invention, a printing apparatus includes a receiving unit configured to receive a print job for printing images of a plurality of pages, an output control unit configured to control a printing unit to execute a printing operation to continuously print each page contained in the plurality of pages on sheets by a number of copies specified by a user, and a changing unit configured to change a sheet discharge position of the sheets after the printing operation is executed, wherein the output control unit controls the printing unit to execute the printing operation after the sheet discharge position is changed by the changing unit and then to discharge the sheets printed by the printing operation to the sheet discharge position changed by the changing unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a printing system according to a first exemplary embodiment of the present invention.

FIG. 2 is a block diagram illustrating a configuration of a printing apparatus.

FIG. 3 is a block diagram illustrating job processing by a printing system.

FIG. 4 illustrates a user interface (UI) to be displayed on a display device of a host computer according to the first exemplary embodiment.

FIG. 5 is a flowchart illustrating a data processing procedure of the printing apparatus according to the first exemplary embodiment.

FIGS. 6A to 6C are schematic diagrams illustrating the state of job output of the printing apparatus according to the first exemplary embodiment.

FIG. 7 illustrates a UI to be displayed on a display device of a host computer according to a second exemplary embodiment of the present invention.

FIG. 8 is a flowchart illustrating a data processing procedure of a printing apparatus according to a third exemplary embodiment of the present invention.

FIG. 9 illustrates a UI to be displayed on a display device of a host computer according to a fourth exemplary embodiment of the present invention.

FIG. 10 is a flowchart illustrating an example of a data processing procedure of a printing apparatus according to the fourth exemplary embodiment.

FIGS. 11A to 11C are schematic diagrams illustrating the state of job output of the printing apparatus according to the fourth exemplary embodiment.

### DESCRIPTION OF THE EMBODIMENTS

Various exemplary embodiments, features, and aspects of the invention will be described in detail below with reference to the drawings.

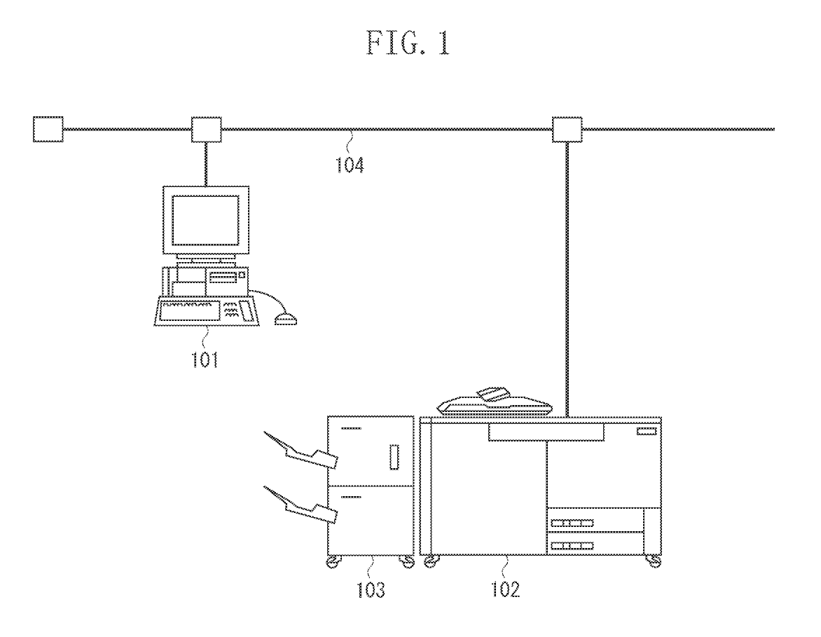

FIG. 1 illustrates a configuration of a printing system according to a first exemplary embodiment of the present invention. The printing system is a system example in which an information processing apparatus (host computer) 101 and a printing apparatus 102 are connected via a network 104. This example illustrates a case in which the printing apparatus 102 is configured by a multifunction peripheral (MFP). However, it may also be configured by a printing apparatus which executes only a printing function. The printing apparatus 102 illustrated in the present exemplary embodiment has the function of receiving and processing a job specified with multiple copy printing from the information processing apparatus 101. The multiple copy printing is a concept including group printing processing and collate printing processing.

In FIG. 1, the host computer 101 includes a controller unit containing a central processing unit (CPU), a read only memory (ROM), and a random access memory (RAM) as a hardware resource. The host computer 101 comprehensively controls processing to input and output devices. The host computer 101 is connected with an external storage device such as a hard disk. The host computer 101 reads an operating system (OS) installed in the external storage device into the RAM.

Further, the host computer 101 executes the installed application. Thus, the host computer 101 executes data processing to be required by a user.

Furthermore, the host computer 101 is installed with a printer driver, a facsimile driver, and the like for output of a job to the printing apparatus 102. The host computer 101 is configured to execute setting of job processing using a UI screen which is provided by each driver.

The printing apparatus 102 is configured by, for example, an MFP. The printing apparatus 102 includes a scanner and a printer. The printing apparatus 102 feasibly has a copy function, a print function, a data transmission and receiving function, and a box function.

Further, the printing apparatus 102 is connected with a finisher (finish device) 103 for executing sheet processing to execute sheet post processing based on a group sorting function and a stapling function.

Furthermore, the printing apparatus 102 can also transmit image data read by a scanner to another device and print printing data transmitted from the host computer 101.

This system illustrates a system in which one information processing apparatus 101 is connected for purposes of illustration. However, a plurality of information processing apparatuses 101 and printing apparatuses 102 may also be connected on the network.

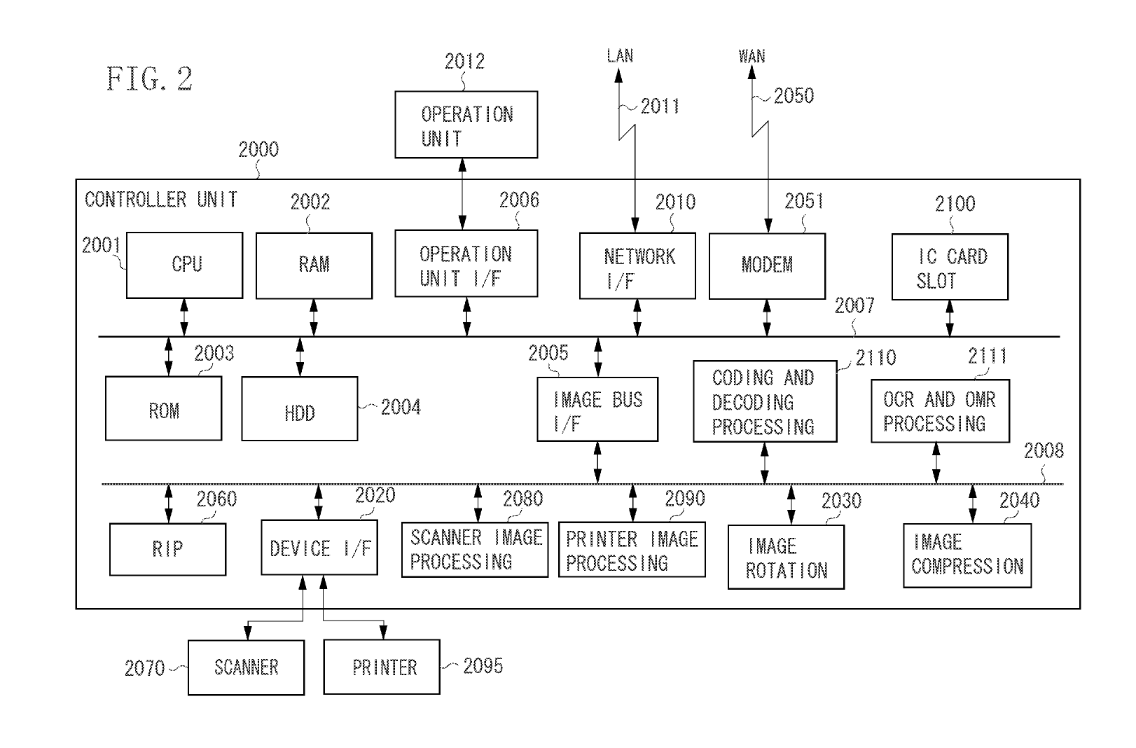

FIG. 2 is a block diagram illustrating a configuration of the printing apparatus 102 illustrated in FIG. 1. In FIG. 2, a system controller (controller unit) 2000 is connected with a scanner 2070, which is an image input device, and a printer 2095, which is an image output device.

On the other hand, the system controller 2000 is connected with a local area network (LAN) 2011 and a wide area network (WAN) 2051. Thus, the system controller 2000 functions as a controller for executing input and output of image information and device information.

A CPU 2001 is a controller for controlling the whole system. A RAM 2002 is a system work memory to cause the CPU 2001 to operate. The RAM 2002 is also used to temporarily store image data. The CPU 2001 loads a boot program from a ROM 2003, which functions as a boot ROM, into the RAM 2002 to control each device connected to a system bus 2007.

A hard disk drive (HDD) 2004 stores system software and image data. An operation unit interface (I/F) 2006 is an interface unit with an operation unit (UI) 2012 having a touch panel and outputs image data to be displayed on the operation unit 2012 to the operation unit 2012.

Further, the operation unit I/F 2006 plays a part in transmitting information input from the operation unit 2012 by a user of this system to the CPU 2001. A network I/F 2010 is connected to the LAN 2011 to execute input and output of information. A modem 2050 is connected to the WAN 2051 to execute input and output of information. The above-described devices are disposed on the system bus 2007.

An image bus I/F 2005 is a bus bridge which connects the system bus 2007 with an image bus 2008 that transfers image data at a high speed to convert a data structure. The image bus 2008 is configured by a peripheral component interconnect (PCI) bus or IEEE1394.

Each device connected on the image bus 2008 will be described below. A raster image processor (RIP) 2060 rasterizes a bit map image from page-description language (PDL) code. A device I/F unit 2020 connects the system controller 2000 with the scanner 2070 and the printer 2095, which are image input and output devices. The device I/F unit 2020 executes synchronous/asynchronous conversion of image data.

A scanner image processing unit 2080 executes correction, manipulation, and editing on input image data. A printer image processing unit 2090 executes correction, resolution conversion, and the like of a printer on printed output image data.

An image rotation unit 2030 executes rotation of image data. An image compression unit 2040 executes compression/expansion processing such as Joint Photographic Experts Group (JPEG) in multilevel image data, and Joint Bi-level Image Experts Group (JBIG), modified modified relative element address designate (MMR), and modified Huffman (MH) in binary image data. An IC card slot 2100 executes user authentication by IC card media. A user in performing a job is identified by this user authentication.

Further, an appropriate Personal Identifier Number (PIN) code is input after the IC card media are inserted. Thus, input and output of a key to be used in coding and decoding can be executed.

A coding and decoding processing unit 2110 is a hardware accelerator board which executes coding and decoding processing of data using a key of the IC card slot 2100 and a key peculiar to a device. An optical character reader (OCR) and optical mark reader (OMR) processing unit 2111 decodes character information contained in image data and a two-dimensional bar code to code the character.

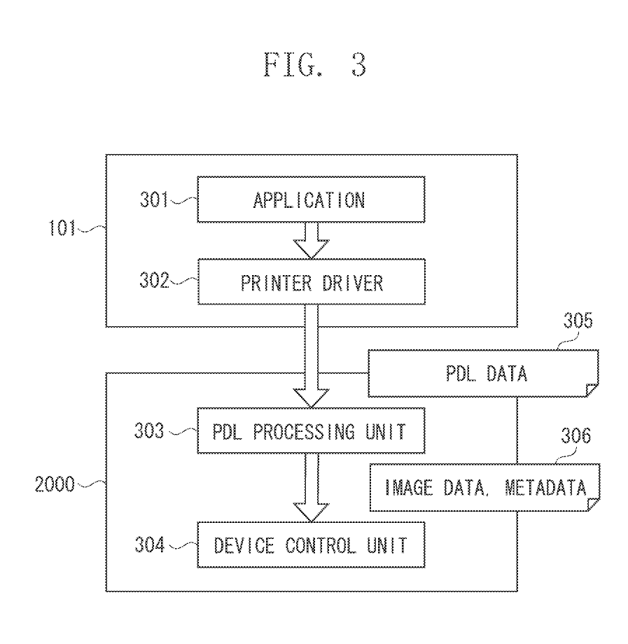

FIG. 3 is a block diagram illustrating job processing by a printing system according to the present exemplary embodiment. The present exemplary embodiment corresponds to a flow in which the printing system processes a print job transmitted from the host computer 101.

In FIG. 3, when an application 301 stored in a storage device (not illustrated) on the host computer 101 instructs printing, a printer driver 302 stored in the storage device similarly to the application generates page-description language (PDL) data 305 and transmits the PDL data 305.

A PDL processing unit 303 generates image data and print information metadata from the PDL data transferred from the host computer 101 to the system controller 2000 of the printing apparatus 102 via the network 104. Then, the PDL processing unit 303 transmits the generated image data and print information metadata to a device control unit 304. The PDL processing unit 303 determines whether group printing is set to a job received from the host computer 101. In the group printing, each page which is printed by a printer is discharged in turn for a specified number of copies. More specifically, the PDL processing unit 303 determines whether a sub-number of copies that can be specified in the total number of copies specified in a job is specified.

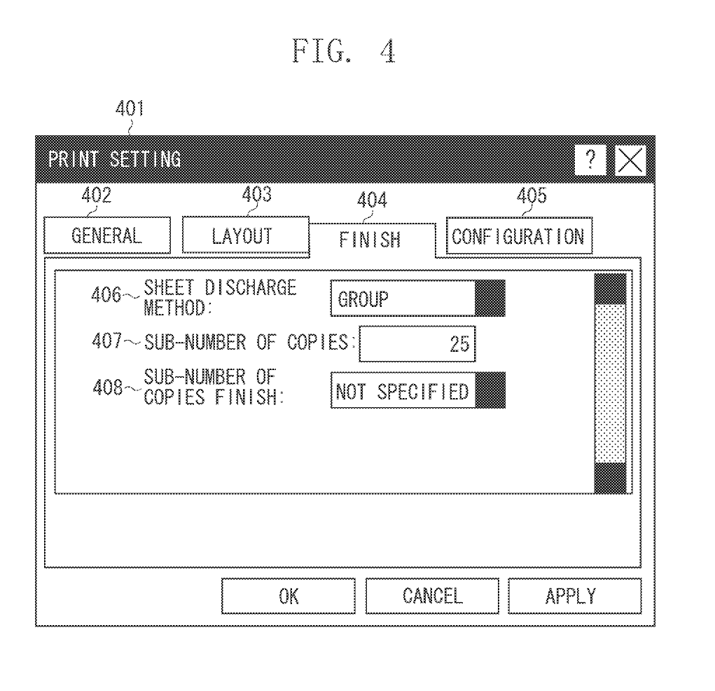

The device control unit 304 transmits image data and print control commands to the printer 2095 to start printing. Specifically, when the PDL processing unit 303 determines that a print job specified with a sub-number of copies unit on a user interface illustrated in FIG. 4 is received, the PDL processing unit 303 controls the printer 2095 to change a page to be printed in turn in units of a sub-number of copies to execute the group printing.

The PDL processing unit 303 and the device control unit 304 include the CPU 2001, the RAM 2002, the ROM 2003, and the HDD 2004. A procedure illustrated in each flowchart is stored in any one of the RAM 2002, the ROM 2003, and the HDD 2004. The procedure is executed by the CPU 2001.

FIG. 4 illustrates an example of a user interface to be displayed on a display device of the host computer 101 illustrated in FIG. 1. This example corresponds to a print setting screen to be provided by the printer driver 302 installed in the host computer 101. Further, this screen can be used to receive a print request from an application and is displayed on the display device by the printer driver 302. Then, the screen receives a print setting request from a user.

In FIG. 4, a print setting window 401 is displayed on the display device when the print request is executed from the application to be started up. A general setting tab 402 is used to specify a number of copies or the like.

A layout tab 403 is used to specify two-sided printing and page layout. A finish tab 404 is used to execute setting of a sheet discharge method, such as sorting and stapling, and finish. A configuration tab 405 is used to display the configuration of the printing apparatus.

The finish tab 404 includes setting of print options. In a sheet discharge method field 406, “group” is specified in FIG. 4. In finish processing, as setting other than this, “not specified”, “sorting”, and “staple sorting” can be set.

A sub-number of copies field 407 is set when group output is executed in units of a sub-number of copies within one job. This example corresponds to a case in which the sub-number of copies 407 is set to, for example, 25 copies.

The total number of copies of a print job is specified by “number of copies” (not illustrated) in the general tab 402. In the present exemplary embodiment, the number of copies is assumed to be set to “60 copies”.

A sub-number of copies finish field 408 is used to specify the type of finish processing in units of a sub-number of copies. In FIG. 4, “not specified” is set in which finish processing is not executed. As another setting, “shift”, “inserted sheet”, or the like can be set. The device control unit 304 executes any of the above-described finish processing on a bundle of sheets to be discharged in units of a sub-number of copies according to the content specified in the sub-number of copies finish field 408. The shift processing is to change the sheet discharge position of recording sheets so as to result in a state in which a bundle of sheets to be discharged hereafter is displaced by a predetermined width with respect to the already discharged bundle of sheets. The inserted sheet processing is to insert a partition sheet (inserted sheet) between a bundle of sheets that has already been discharged and a bundle of sheets that is to be discharged hereafter.

When the printer driver 302 receives a print button being pressed by a user after the setting illustrated in FIG. 4 is executed, the printer driver 302 generates PDL data to transmit it to the system controller 2000.

When the PDL processing unit 303 in the system controller 2000 receives PDL data, the PDL processing unit 303 executes RIP processing in which an image to be output by the printing apparatus is rasterized and generated from the PDL data, and generates print job metadata to instruct printing to the printer 2095.

In the print job metadata, a finish block is set in one print job, and a document block and the attribute of the print job are hierarchically set in the finish block. A plurality of finish blocks can be included in the print job. The finish block is used to manage pages of the print job and the attribute of finish processing such as stapling and stapling. The document block is used to manage the content and the color attribute of the print job.

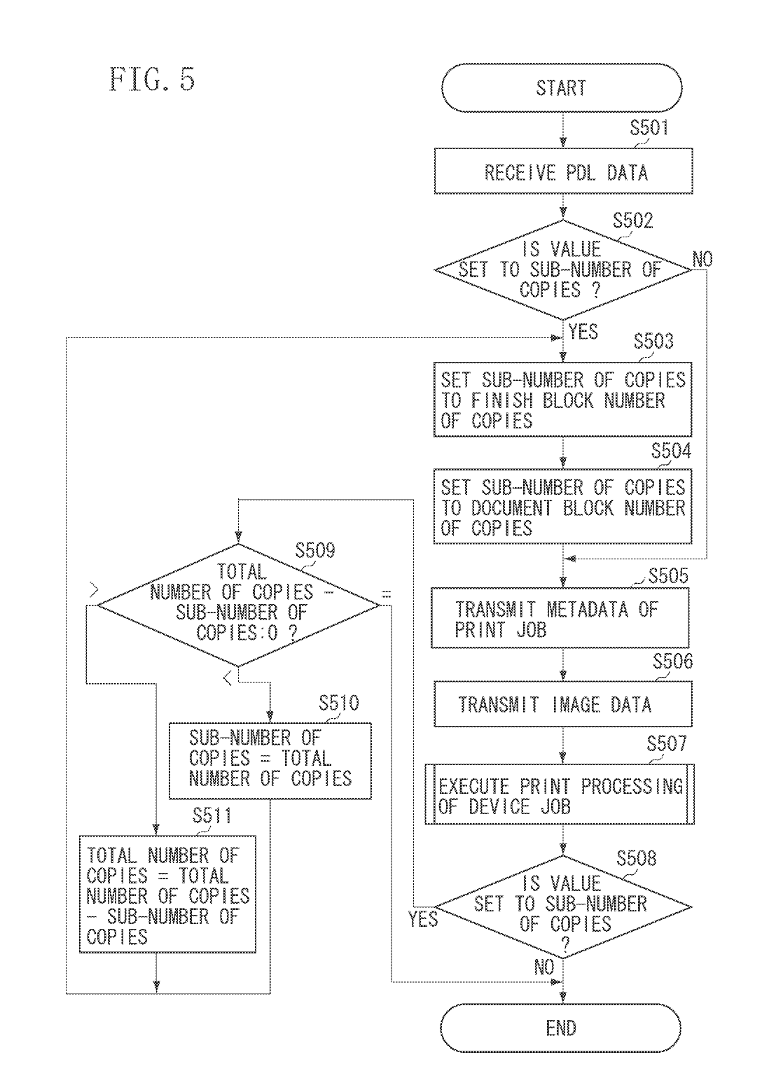

FIG. 5 is a flowchart illustrating an example of a data processing procedure of the printing apparatus according to the present exemplary embodiment. This example is an example of the PDL processing of a print job specified with a sub-number of copies by the print driver on the host computer 101. Each step is realized by causing the CPU 2001 to load a control program into the RAM 2002 to execute it. In the following description, processing to be executed by the CPU 2001 as the PDL processing unit 303 and the device control unit 304 in FIG. 3 will be described. A series of control in analyzing a job received from the host computer 101 to execute finish processing in units of a sub-number of copies will be described below.

In step S501, the PDL processing unit 303 receives PDL data generated by the printer driver 302 in the host computer 101 as a print job from the LAN 2011 via the network I/F 2010.

Next, in step S502, the PDL processing unit 303 determines whether a sub-number of copies is set to the PDL data. If the PDL processing unit 303 determines that the sub-number of copies is set (YES in step S502), the processing proceeds to step S503. If the PDL processing unit 303 determines that the sub-number of copies is not set (NO in step S502), the processing proceeds to step S505.

Then, in step S503, the PDL processing unit 303 sets the sub-number of copies to the finish block number of copies. Normally, the PDL processing unit 303 sets the number of copies (total number of copies) set in the general setting tab 402 illustrated in FIG. 4. However, when a value is set to the sub-number of copies, the sub-number of copies is set. Then, in step S504, the PDL processing unit 303 sets the sub-number of copies to the document block number of copies. Similar to the setting of the finish block, when the sub-number of copies is not set to the document block number of copies, the PDL processing unit 303 sets the number of copies set in the general tab 402.

Next, in step S505, the PDL processing unit 303 transmits metadata of a print job to the device control unit 304. Then, in step S506, the PDL processing unit 303 transmits raster image data rasterized from the PDL data to the device control unit 304.

Next, in step S507, the device control unit 304 issues control commands from the metadata of the print job and the image data to the printer 2095 to start print processing. When a sub-number of copies is set, the device control unit 304 causes the printer 2095 to execute print processing for the sub-number of copies.

Then, in step S508, the PDL processing unit 303 determines whether a value is set to the sub-number of copies. If the PDL processing unit 303 determines that a value is set (YES in step S508), the processing proceeds to step S509. If the PDL processing unit 303 determines that no value is set (NO in step S508), the processing ends.

In step S509, the device control unit 304 determines whether “total number of copies minus sub-number of copies” is “0”. In step S509, when the device control unit 304 determines that “total number of copies minus sub-number of copies” is “0”, since print processing for the total number of copies ends, this processing ends. On the other hand, when the device control unit 304 determines that “total number of copies minus sub-number of copies” is larger than “0”, the processing proceeds to step S511. The device control unit 304 replaces total number of copies with “total number of copies minus sub-number of copies”, the processing returns to step S503. On the other hand, if the device control unit 304 determines that “total number of copies minus sub-number of copies” is smaller than “0”, when the sub-number of copies is printed, it exceeds the total number of copies. Thus, in step S510, the device control unit 304 replaces sub-number of copies with total number of copies, and the processing then proceeds to step S503.

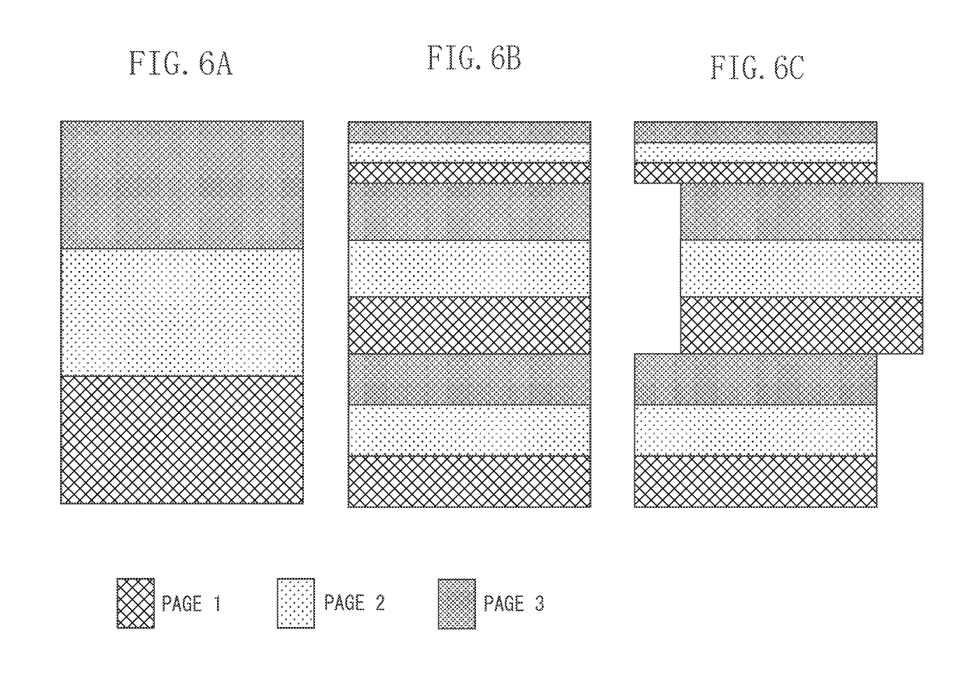

Referring to FIGS. 6A to 6C, specific processing in a case in which in the print job set in FIG. 4, a number of copies (total number of copies) is set to 60, a sub-number of copies is set to 25, and the sub-number of copies finish is set as not specified will be described below. In this case, according to a flowchart illustrated in FIG. 5, output of group printing is executed in 25 copies, 25 copies, and 10 copies. At this time, image data transmission in step S506 occurs three times, which is a value obtained by the total number of copies by the sub-number of copies set in the print job to be received. In FIGS. 6A to 6C, the state of output in a case in which 25 copies as a sub-number of copies (total number of copies being 60) are set to a document having three pages is illustrated.

FIGS. 6A to 6C are schematic diagrams illustrating the state of job output of the printing apparatus according to the present exemplary embodiment. FIG. 6A illustrates the result of output when a job of three pages is output at 60 copies in a group. From the bottom, page 1, page 2, and page 3 are output in turn at 60 copies each. This corresponds to a bundle of print of the result of the normal group printing. FIG. 6B illustrates output when the sub-number of copies is 25 and the sub-number of copies finish is not specified. In this state, printing of each page is repeated in turn in units of the sub-number of copies by the printing apparatus 102. This state corresponds to a state in which a bundle of prints with each page making a circuit results in a bundle of prints in units of the sub-number of copies.

Further, the state of output in a case in which in the sub-number of copies finish, shift is set is illustrated in FIG. 6C. This corresponds to a state in which shift finish is specified as the sub-number of copies finish on the user interface illustrated in FIG. 4. The shift finish is realized to move the position of sheets discharged from the printing apparatus 102. Specifically, a sheet discharge tray is shifted in a direction orthogonal to a sheet conveyance direction. Thus, the discharge position of sheets can be shifted.

This allows finish processing to be executed in units of a sub-number of copies. Thus, sorting work for each sub-number of copies to be performed by a user after printing is completed can be reduced. Further, group mode output in units of a specified number of copies and finish processing of a group mode output product can be executed with one printing instruction without input with printing divided into a plurality of print jobs. Thus, such an operation can be prevented that when the divided and input plurality of print jobs is input in a print queue, the order of priority of another print job may be raised by a user operation and this another job may be inserted into the plurality of print jobs. Accordingly, a printed result of such another print job can be prevented from being misplaced in a printed result of the plurality of print jobs.

In the above-described first exemplary embodiment, when the number of settings of the sub-number of copies is one has been described. However, a plurality of settings of the sub-number of copies intended to execute finish processing by the sub-number of copies can be set, thereby allowing group output processing at different sub-numbers of copies to be executed by one print job. A second exemplary embodiment of the present invention will be described below. The configuration of hardware is similar to that in the first exemplary embodiment.

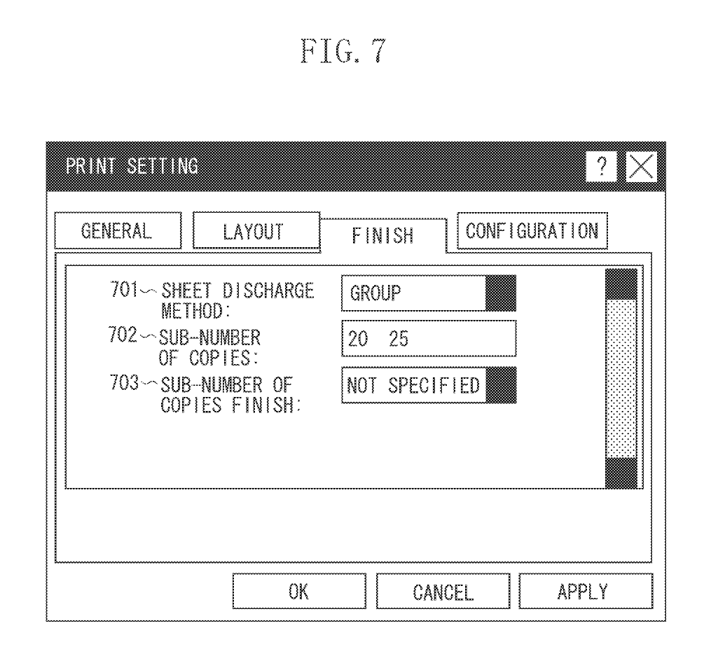

FIG. 7 illustrates an example of a user interface to be displayed on the display device of the host computer 101 illustrated in FIG. 1. This example corresponds to a print setting screen provided by the print driver 302 installed in the host computer 101. Further, this screen is used to receive a print request from an application and is displayed on the display device by the printer driver 302. Then, the screen is used to receive a print setting request from a user.

In FIG. 7, a discharge method field 701 indicates a state in which “group” is specified. As setting other than this, similarly to the first exemplary embodiment, “not specified”, “sorting”, and “staple sorting” can be set. In finish processing, “shift”, “inserted sheet”, and the like other than sorting can also be set.

A sub-number of copies field 702 is set when group output is executed in units of a sub-number of copies within one job. However, the present exemplary embodiment is configured to allow particularly setting of a plurality of numbers of copies to be input. FIG. 7 corresponds to a state in which currently two numbers of copies of 20 copies and 25 copies are set. Further, the sub-number of copies is controlled in a specified order. In the present exemplary embodiment, first 20 copies are processed and next 25 copies are processed. Since this specified order is the input order of the sub-number of copies by a user, the user can interchange 25 copies and 20 copies. The total number of copies of a print job is specified by “number of copies” within the detail setting (not illustrated) in the general tab 402. In the present exemplary embodiment, “60 copies” are assumed to be set as the total number of copies. In this case, the sub-number of copies finish is executed in 20 copies, in 25 copies, and then in 15 copies (60-20-25).

A sub-number of copies finish field 703 is used to specify the type of finish processing in units of a sub-number of copies. Currently, the sub-number of copies finish field 703 corresponds to a state in which “not specified” is set, in which finish processing is not executed. In the sub-number of copies finish field 703, as another setting, similarly to the first exemplary embodiment, “shift”, “inserted sheet”, and the like can be set.

In the present exemplary embodiment, based on the procedure in the flowchart illustrated in FIG. 5, job processing can be executed in the specified order of the sub-number of copies as a sub-number of copies 1 (in the present exemplary embodiment, 20 copies), a sub-number of copies 2 (similarly, 25 copies), and so on. Two or more of the sub-numbers of copies can be set. A user sets an arbitrary sub-number of copies. Thus, different sheet post processing can also be executed on each number of copies. Accordingly, if the sub-number of copies is within a numeral value of not more than the total number of copies and also the integrated value of the sub-number of copies is within the total number of copies, since a user can freely set the sub-number of copies, finish processing in which the sub-number of copies to be subjected to group printing is different can freely be executed.

In the first exemplary embodiment, an example has been described in which the PDL processing unit 303 transmits print data that includes the same page group for each processing of the sub-number of copies to the device control unit 304. On the other hand, it may also be configured such that from a relationship between setting of one sub-number of copies and a total number of copies, as described below, the number of sub jobs is determined and a sub print job is set, thereby allowing a plurality of times of processing of the sub-number of copies finish to be executed with one transmission of image data. The sub job is data corresponding to a higher rank of the finish block of print metadata described in the first exemplary embodiment. The sub job is configured to retain attribute information on the finish block and the document block.

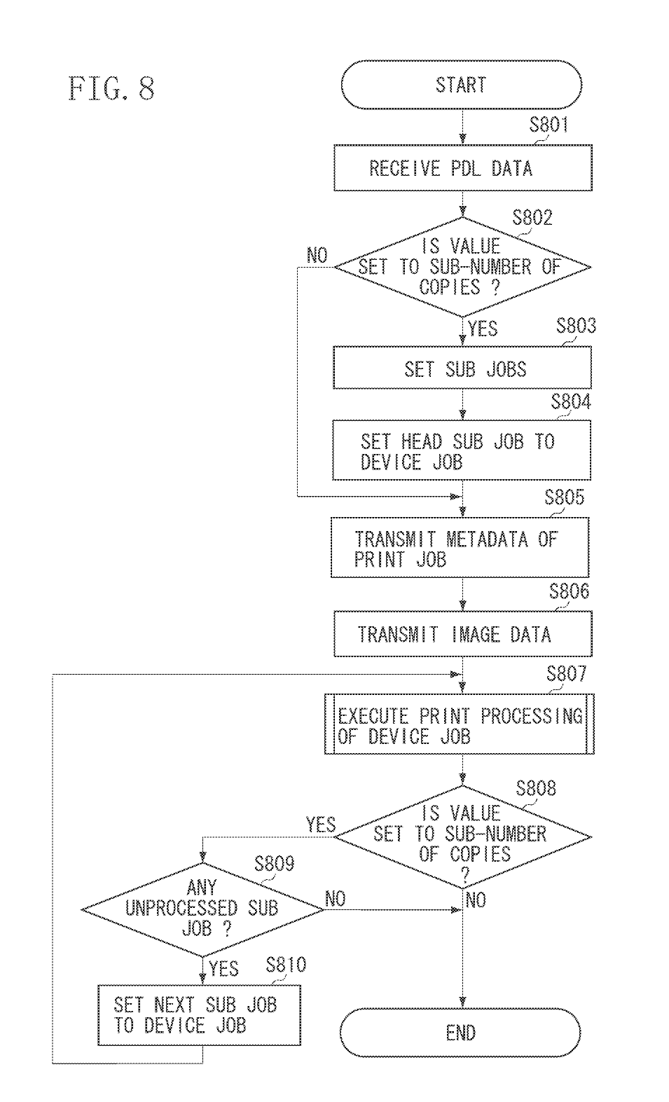

FIG. 8 is a flowchart illustrating an example of a data processing procedure of the printing apparatus according to a third exemplary embodiment of the present invention. This example is an example of PDL processing of a print job of group sheet discharge specified with a sub-number of copies. Each step is realized by causing the CPU 2001 to load a control program into the RAM 2002 to execute it. In the following description, processing to be executed by the CPU 2001 as the PDL processing unit 303 and the device control unit 304 in FIG. 3 will be described. Since processing in steps S801 to S807 is similar to that in steps S501 to S507, the description thereof is not repeated. In the present exemplary embodiment, similarly to the first exemplary embodiment, a sub-number of copies is set by the printer driver 302. In step S801, the PDL processing unit 303 receives PDL data as a print job generated by the printer driver 302 from the LAN 2011 via the network I/F 2010.

In step S802, the PDL processing unit 303 determines whether a sub-number of copies is set to the PDL data. If the PDL processing unit 303 determines that the sub-number of copies is set (YES in step S802), the processing proceeds to step S803. If the PDL processing unit 303 determines that the sub-number of copies is not set (NO in step S802), the processing proceeds to step S805. Then, in step S803, the PDL processing unit 303 sets sub jobs from the sub-number of copies set to the PDL data.

As an example that the sub jobs are set, a case in which a total number of copies is “60” and a sub-number of copies is “25” will be described. The PDL processing unit 303 sets the sub jobs as follows from a total number of copies NA and a sub-number of copies NS:

Number of sub jobs N=3
Number of sub jobs=NA/NS (when NA%NS is 0, % is residue)
Number of sub jobs=NA/NS+1 (other than the above)
Sub job attribute
Sub job 1 (finish block number of copies=25, document block number of copies=25)
Sub job 2 (finish block number of copies=25, document block number of copies=25)
Sub job 3 (finish block number of copies=10, document block number of copies=10)

Next, in step S804, the PDL processing unit 303 sets the head sub job (sub job 1) to a device job. Specifically, the sub job attribute is set to the finish block number of copies and the document block number of copies. Next, in step S805, the PDL processing unit 303 transmits metadata of the print job to the device control unit 304. Then, in step S806, the PDL processing unit 303 transmits raster image data rasterized from the PDL data to the device control unit 304. Next, in step S807, the device control unit 304 issues control commands from the metadata of the print job and the image data to the printer 2095 to start printing. Then, in step S808, the PDL processing unit 303 determines whether a value is set to the sub-number of copies. If the PDL processing unit 303 determines that a value is set to the sub-number of copies (YES in step S808), the processing proceeds to step S809. If the PDL processing unit 303 determines that no value is set (NO in step S808), the processing ends.

Then, in step S809, the device control unit 304 determines whether any unprocessed sub job is present. If the device control unit 304 determines that all of the sub jobs are processed and no unprocessed sub job is present (NO in step S809), the processing ends . On the other hand, If the device control unit 304 determines that an unprocessed sub job is present (YES in step S809), then in step S810, the device control unit 304 sets a next sub job (when processed sub job is sub job 1, next sub job is sub job 2) to the device job. Then, the processing returns to step S807. Thus, the PDL processing unit 303 transmits image data to the device control unit 304 once, thereby allowing a plurality of times of processing of the sub-number of copies finish to be executed on a bundle of prints subjected to group printing.

In a fourth exemplary embodiment of the present invention, a case in which the option of setting “specified number of sheets finish” and “ignore page break” is provided to the finish tab on the printer driver 302 in the first exemplary embodiment will be described. The present exemplary embodiment allows finish processing on the same page in units of a specified number of sheets (10 sheets/10 sheets/5 sheets) to be executed when the sub-number of copies is set to 25 copies.

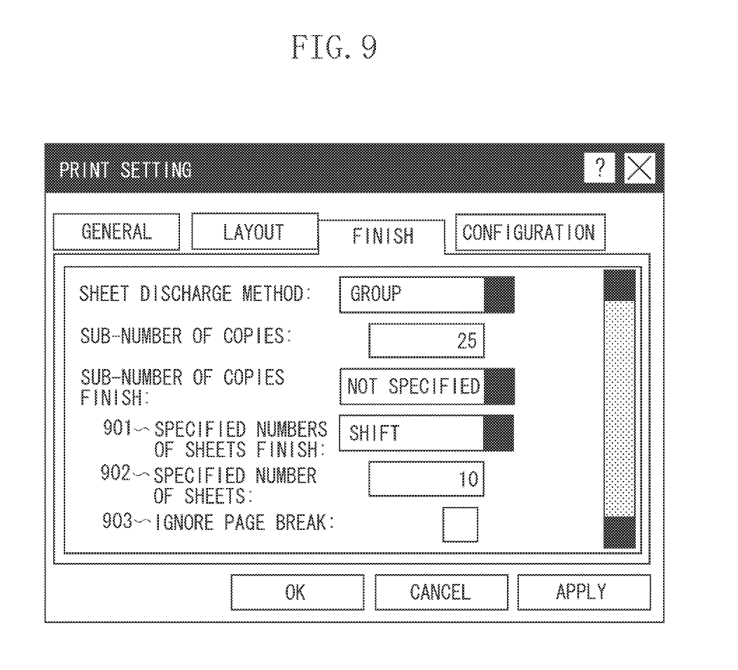

FIG. 9 illustrates an example of a user interface to be displayed on the display device of the host computer 101 illustrated in FIG. 1. This example corresponds to a print setting screen to be provided by the printer driver 302 installed in the host computer 101. Further, this screen is used to receive a print request from an application and is displayed on the display device by the printer driver 302. Then, the screen is used to receive a print setting request from a user. The present exemplary embodiment corresponds to a user interface to specify finish processing so as to execute the finish processing for each bundle of sheets in which the specified number of sheets are printed when the printing apparatus executes group printing of each page in units of a sub-number of copies.

In FIG. 9, a specified number of sheets finish field 901 is used to specify “shift”. As finish processing other than this, “not specified”, “shift”, “inserted sheet”, and “shift inserted sheet” can be set.

A specified number of sheets field 902 is used to specify the number of sheets subjected to the specified number of sheets finish by a numeral value. A check box 903 is used to set either of ON/OFF to “ignore page break”. When the check box 903 is set ON, processing is executed as it is without resetting count of the specified number of sheets when a page is changed. More specifically, the check box 903 is set ON when the specified number of sheets finish is executed with the specified number of sheets considered to be important and pages mixed. This allows processing of the specified number of sheets finish to be differently executed when group printing is executed.

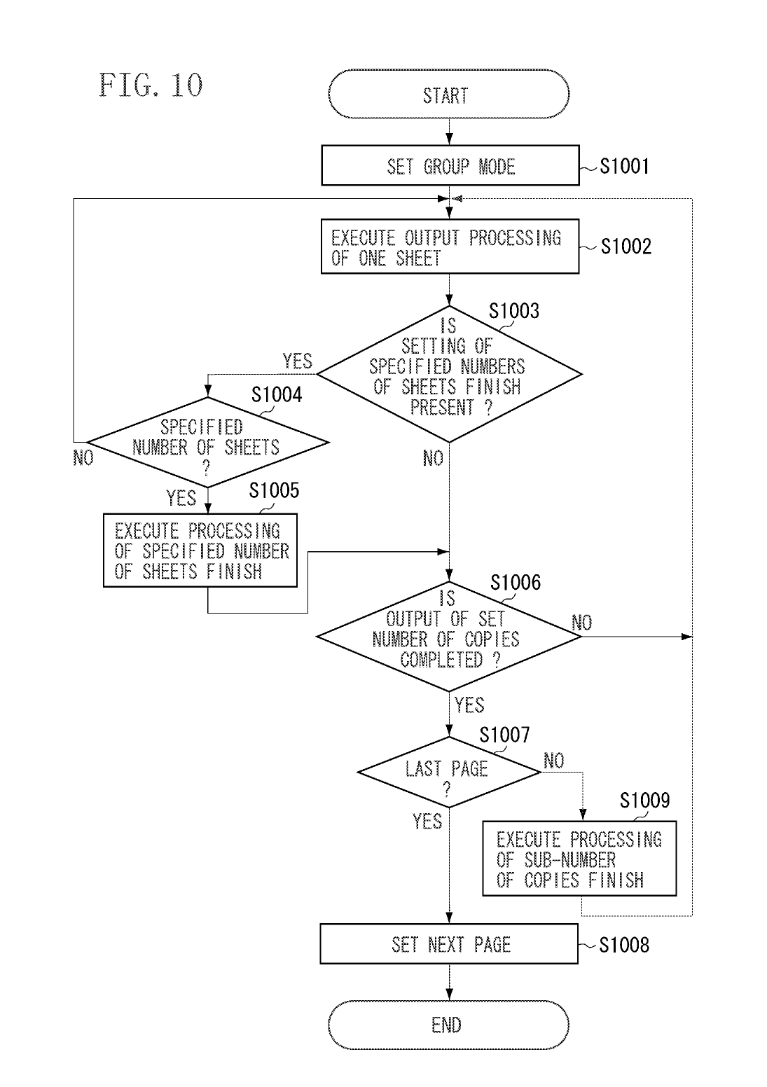

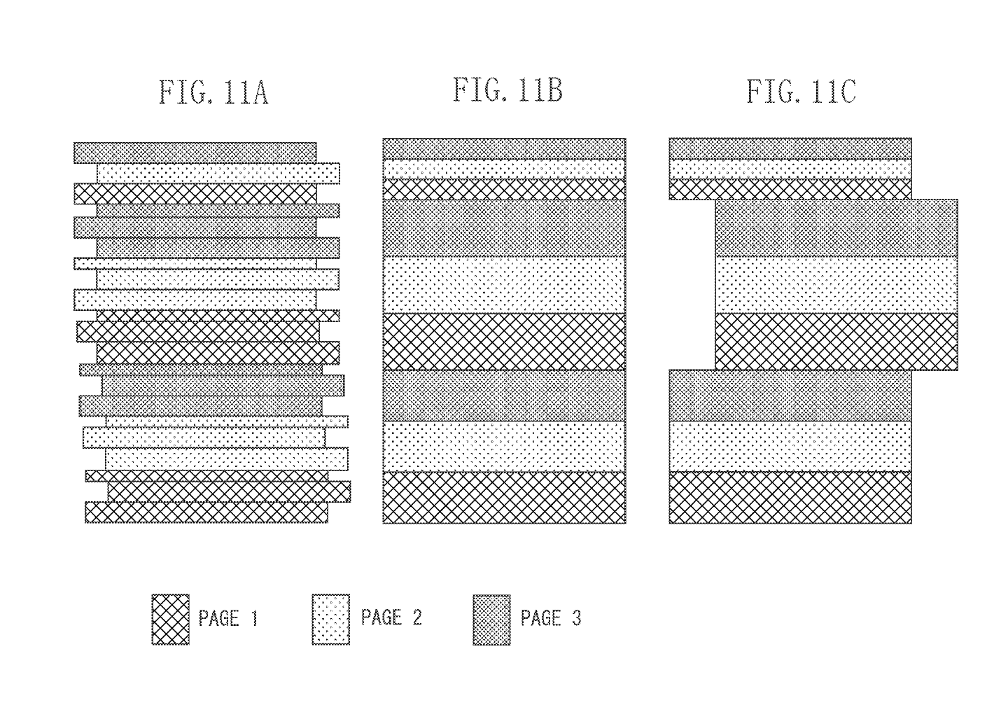

FIG. 10 is a flowchart illustrating an example of a data processing procedure of the printing apparatus according to the fourth exemplary embodiment. This example is an example of processing of the specified number of sheets finish in group printing. Each step is realized by causing the CPU 2001 to load a control program into the RAM 2002 to execute it. In the following description, processing to be executed by the CPU 2001 as the PDL processing unit 303 and the device control unit 304 in FIG. 3 will be described. This example is a job processing example when it is determined that group printing of each page is specified to a print job received by the printing apparatus in units of a sub-number of copies and also the specified number of sheets printing is specified. More particularly, this example is a processing example in which when the printing apparatus executes group printing of each page in units of a sub-number of copies, finish processing is executed for each bundle of sheets, which is printed with the specified number of sheets (refer to a finish processing example in FIG. 11A).

In step S1001, the device control unit 304 sets a group mode in the sheet discharge mode set on metadata of a print job. Next, in step S1002, the device control unit 304 executes output processing of one sheet according to the setting of the sheet discharge mode instep S1001. At this time, the device control unit 304 counts the number of sheets subjected to output processing. Then, in step S1003, the device control unit 304 determines whether a specified number of sheets of processing of the specified number of sheets finish is set in units of a sub-number of copies and also as finish processing. Then, the device control unit 304 determines whether the check box 903 is set ON. If the device control unit 304 determines that the specified number of sheets of processing of the specified number of sheets finish is not set (NO in step S1003), the processing proceeds to step S1006. If the device control unit 304 determines that the specified number of sheets is set (YES in step S1003), the processing proceeds to step S1004. In step S1004, the device control unit 304 determines whether the output number of sheets is the specified number of sheets. If the device control unit 304 determined that the output number of sheets is not the specified number of sheets (NO instep S1004), the processing returns to step S1002. Then, the processing proceeds to processing of a next sheet.

On the other hand, if the device control unit 304 determines that the output number of sheets is the specified number of sheets (YES in step S1004), the processing proceeds to step S1005. In step S1005, the device control unit 304 executes finish processing specified by the printer driver 302 as processing of the specified number of sheets finish. Further, the device control unit 304 resets count of the number of sheets. Next, in step S1006, the device control unit 304 determines whether output of the set number of copies is completed. If the device control unit 304 determines that output of the set number of copies is not completed (NO in step S1006), the processing returns to step S1002.

On the other hand, if the device control unit 304 determines that output of the set number of copies is completed (YES instep S1006), the processing proceeds to step S1007. In step S1007, the device control unit 304 determines whether processing of the last page is completed. If the device control unit 304 determines that processing of the last page is completed (YES in step S1007), the processing proceeds to step S1008.

On the other hand, if the device control unit 304 determines that the processed page is not the last page (NO in step S1007), the processing proceeds to step S1009. In step S1008, the device control unit 304 executes finish processing set in the sub-number of copies finish by the print driver 302 and then, the processing ends. In step S1009, the device control unit 304 sets a page to be output to a next page. Further, the device control unit 304 simultaneously resets count of the specified number of sheets when “ignore page break” is not checked. The device control unit 304 does not reset count thereof when “ignore page break” is checked.

FIGS. 11A to 11C are schematic diagrams illustrating the state of job output of the printing apparatus according to the fourth exemplary embodiment. This example is an output example of the specified number of sheets finish in the fourth exemplary embodiment. This example is a print job of group printing of three pages, a total number of copies of 60 copies, and a sub-number of copies of 25 copies. FIG. 11A illustrates the state of finish processing in which the sub-number of copies finish is “not specified”, the specified number of sheets finish is “shift”, a specified number of sheets is “10”, and a check box of “ignore page break” is “OF”.

FIG. 11B corresponds to the state of finish processing in which the sub-number of copies finish is “not specified” and the specified number of sheets finish is “not specified”. FIG. 11C illustrates the state of finish processing in which the sub-number of copies finish is “shift” and the specified number of sheets finish is “not specified”. This allows discrimination in a unit for distribution in units of pages and discrimination for checking the number of sheets to be easily executed.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-296525 filed Dec. 26, 2009, which is hereby incorporated by reference herein in its entirety.

what is claimed is:

1. A printing apparatus comprising:
a receiving unit configured to receive a print job for printing images of a plurality of pages;
an output control unit configured to control a printing unit to execute a printing operation to continuously print each page contained in the plurality of pages on sheets by a number of copies specified by a user; and
a changing unit configured to change a sheet discharge position of the sheets after the printing operation is executed,
wherein the output control unit controls the printing unit to execute the printing operation after the sheet discharge position is changed by the changing unit and then to discharge the sheets printed by the printing operation to the sheet discharge position changed by the changing unit.

2. The printing apparatus according to claim 1, further comprising:
a post processing unit configured to execute a post process on the sheets printed by the printing unit; and
a post processing control unit configured to control the post processing unit to execute the post process each time a predetermined number of sheets contained in a plurality of sheets printed by the printing operation are discharged.

3. The printing apparatus according to claim 2, wherein the post process is a change of the discharge position or insertion of an inserted sheet.

4. A printing apparatus comprising:
a printing unit configured to print an image on a sheet; and
an output control unit configured to cause the printing unit to execute a printing operation to continuously print each page contained in image data of a plurality of pages on sheets in turn by a specified number of copies,
wherein the output control unit controls the printing unit to repeat the printing operation a predetermined number of times.

5. A method for controlling a printing apparatus, the method comprising:
printing an image on a sheet by a printing unit;
changing a sheet discharge position of the sheet printed by the printing unit;
controlling the printing unit to execute a printing operation to continuously print an image of each page contained in image data of a plurality of pages on sheets in turn by a specified number of copies;
changing the sheet discharge position after the printing operation is executed; and
controlling the printing unit to execute the printing operation after the sheet discharge position is changed and then to discharge the sheets printed by the printing operation to the changed sheet discharge position.

6. A computer-readable storage medium storing a program that causes a computer to perform a method for controlling a printing apparatus, the method comprising:
printing an image on a sheet by a printing unit;
changing a sheet discharge position of the sheet printed by the printing unit;
controlling the printing unit to execute a printing operation to continuously print an image of each page contained in image data of a plurality of pages on sheets in turn by a specified number of copies;
changing the sheet discharge position after the printing operation is executed; and
controlling the printing unit to execute the printing operation after the sheet discharge position is changed and then to discharge the sheets printed by the printing operation to the changed sheet discharge position.
